(19) United States
(12) Patent Application Publication
(10) Pub. No.: US 2025/0266481 A1
(43) Pub. Date: Aug. 21, 2025

(54) METHOD FOR ACTIVATING POLYMER ELECTROLYTE FUEL CELL

(71) Applicant: HONDA MOTOR CO., LTD., Tokyo (JP)

(72) Inventors: Takuro SASAKI, Saitama (JP); Shinsaku TAKIKAWA, Saitama (JP); Ken TAGAWA, Saitama (JP); Ryo MOCHIZUKI, Saitama (JP)

(21) Appl. No.: 19/046,527

(22) Filed: Feb. 6, 2025

(30) Foreign Application Priority Data
Feb. 19, 2024 (JP) 2024-022930

(51) Int. Cl. H01M 8/1004; H01M 8/10

(52) U.S. Cl. CPC H01M 8/1004; H01M 2008/1095

(57) ABSTRACT

A method for activating a polymer electrolyte fuel cell according to an embodiment of the present invention is adapted to activate a polymer electrolyte fuel cell a membrane electrode assembly in which an anode electrode and a cathode electrode are opposed to each other with a solid polymer membrane interposed therebetween. The method includes pressurizing and feeding a hydrogen-containing humidification gas, which has been humidified, to the anode electrode and pressurizing and feeding an oxygen-containing humidification gas, which has been humidified, or a nitrogen-containing humidification inert gas, which has been humidified, to the cathode electrode, while heating the polymer electrolyte fuel cell at a set temperature in a predetermined range (preferably from 100° C. to 300° C., more preferably from 100° C. to 200° C., and still more preferably from 100° C. to 150° C.).

This application is based on and claims the benefit of priority from Japanese Patent Application No. 2024-022930, filed on 19 Feb. 2024, the content of which is incorporated herein by reference.

### BACKGROUND OF THE INVENTION

### Field of the Invention

The present invention relates to a method for activating a polymer electrolyte fuel cell.

### Related Art

In recent years, research and development of fuel cells that contribute to energy efficiency has been carried out in order to ensure many people have access to affordable, reliable, sustainable, and advanced energy. A polymer electrolyte fuel cell that includes a membrane electrode assembly (MEA) in which an anode electrode and a cathode electrode are opposed to each other with a solid polymer membrane interposed therebetween is known as such a fuel cell. In general, the polymer electrolyte fuel cell exhibits low power generation performance immediately after production. For this reason, it is common to activate the polymer electrolyte fuel cell by way of an activation process (aging) before shipment. A known method for activating a polymer electrolyte fuel cell includes heating the polymer electrolyte fuel cell while feeding a hydrogen-containing humidification gas, which has been humidified, to the anode electrode and feeding an oxygen-containing humidification gas, which has been humidified, or a nitrogen-containing humidification inert gas, which has been humidified, to the cathode electrode, and includes applying a voltage fluctuating in a predetermined range between the cathode electrode and the anode electrode (see, for example, Patent Document 1).

Patent Document 1: PCT International Publication No. WO 2011/125840

### SUMMARY OF THE INVENTION

A challenge for the techniques relating to the polymer electrolyte fuel cells is to shorten the activation process time in order to improve productivity. Therefore, there is a demand for further improvements in conventional activation methods.

The present invention has been made in view of the above circumstances, and an object of the present invention is to provide a method capable of activating a polymer electrolyte fuel cell in a shorter time.

The present inventors have found that the above object can be achieved by feeding predetermined humidification gases to the anode electrode and the cathode electrode of a polymer electrolyte fuel cell while heating the polymer electrolyte fuel cell, or by heating a polymer electrolyte fuel cell, followed by feeding predetermined humidification gases to the anode electrode and the cathode electrode of the polymer electrolyte fuel cell in a state in which the heating is stopped, thereby completing the present invention. Thus, the present invention provides the following.

A first aspect of the present invention provides a method for activating a polymer electrolyte fuel cell having a membrane electrode assembly in which an anode electrode and a cathode electrode are opposed to each other with a solid polymer membrane interposed therebetween, the method including: pressurizing and feeding a hydrogen-containing humidification gas, which has been humidified, to the anode electrode and pressurizing and feeding an oxygen-containing humidification gas, which has been humidified, or a nitrogen-containing humidification inert gas, which has been humidified, to the cathode electrode, while heating the polymer electrolyte fuel cell at a set temperature in a predetermined range.

According to the method for activating a polymer electrolyte fuel cell of the first aspect, the hydrogen-containing humidification gas is fed to the anode electrode, and the oxygen-containing humidification gas or the nitrogen-containing humidification inert gas is fed to the cathode electrode, while the polymer electrolyte fuel cell is being heated, thereby facilitating activation of the catalysts in an anode-side catalyst layer and a cathode-side catalyst layer. Furthermore, water vapor contained in the humidification gases facilitates moistening of the catalyst layers of the anode electrode and cathode electrode and moistening of the solid polymer membrane. In addition, since the hydrogen-containing humidification gas is pressurized and fed to the anode electrode and the oxygen-containing humidification gas or the nitrogen-containing humidification inert gas is pressurized and fed to the cathode electrode, water vapor can be efficiently supplied to the anode electrode and the cathode electrode. As a result, the polymer electrolyte fuel cell can be activated in a shorter time.

According to a second aspect of the present invention, in the method for activating a polymer electrolyte fuel cell of the first aspect, the hydrogen-containing humidification gas and the oxygen-containing humidification gas or the nitrogen-containing humidification inert gas are heated to the set temperature.

The hydrogen-containing humidification gas may decrease in humidity due to being heated when fed to the anode electrode, and the oxygen-containing humidification gas or the nitrogen-containing humidification inert may decrease in humidity due to being heated when fed to the cathode electrode. The method according to the second aspect suppresses the decreases in humidity, thereby making it possible to supply water vapor to the anode electrode and the cathode electrode more efficiently.

According to a third aspect of the present invention, the method for activating a polymer electrolyte fuel cell of the first or second aspect further includes applying a voltage fluctuating in a predetermined range between the cathode electrode and the anode electrode with the cathode electrode set to positive, while heating the polymer electrolyte fuel cell.

The method of the third aspect, which includes applying the voltage between the cathode electrode and the anode electrode, further facilitates progress of the activation of the polymer electrolyte fuel cell.

A fourth aspect of the present invention provides a method for activating a polymer electrolyte fuel cell having a membrane electrode assembly in which an anode electrode and a cathode electrode are opposed to each other with a solid polymer membrane interposed therebetween, the method including: heating the polymer electrolyte fuel cell at a set temperature in a predetermined range; and thereafter, feeding a hydrogen-containing humidification gas, which has been humidified, to the anode electrode and feeding an oxygen-containing humidification gas, which has been humidified, or a nitrogen-containing humidification inert gas, which has been humidified, to the cathode electrode in a state in which the heating is stopped.

According to the activation method of the fourth aspect, heating is performed until the activation of the polymer electrolyte fuel cell progresses, and following stop of the heating, the hydrogen-containing humidification gas is fed to the anode electrode, and the oxygen-containing humidification gas or the nitrogen-containing humidification inert gas is fed to the cathode electrode. As a result, water vapor can be efficiently supplied to each of the anode electrode and the cathode electrode without having to pressurize the hydrogen-containing humidification gas and the oxygen-containing humidification gas or the nitrogen-containing humidification inert gas.

The present invention provides a method capable of activating a polymer electrolyte fuel cell in a shorter time.

### BRIEF DESCRIPTION OF THE DRAWINGS

FIG. 1 is a block diagram illustrating an activation process apparatus that can be used in a method for activating a polymer electrolyte fuel cell according to an embodiment of the present invention;

FIG. 2 is a schematic diagram illustrating an example of a state in which a polymer electrolyte fuel cell is being activated by a method for activating a polymer electrolyte fuel cell according to an embodiment of the present invention; and

FIG. 3 is a schematic diagram illustrating another example of a state in which a polymer electrolyte fuel cell is being activated by a method for activating a polymer electrolyte fuel cell according to an embodiment of the present invention.

### DETAILED DESCRIPTION OF THE INVENTION

Embodiments of the present invention will be described below with reference to the drawings. It should be noted that the present invention is not limited to the following embodiments in any sense, and can be appropriately modified and implemented within a range not deviating from the spirit of the present invention.

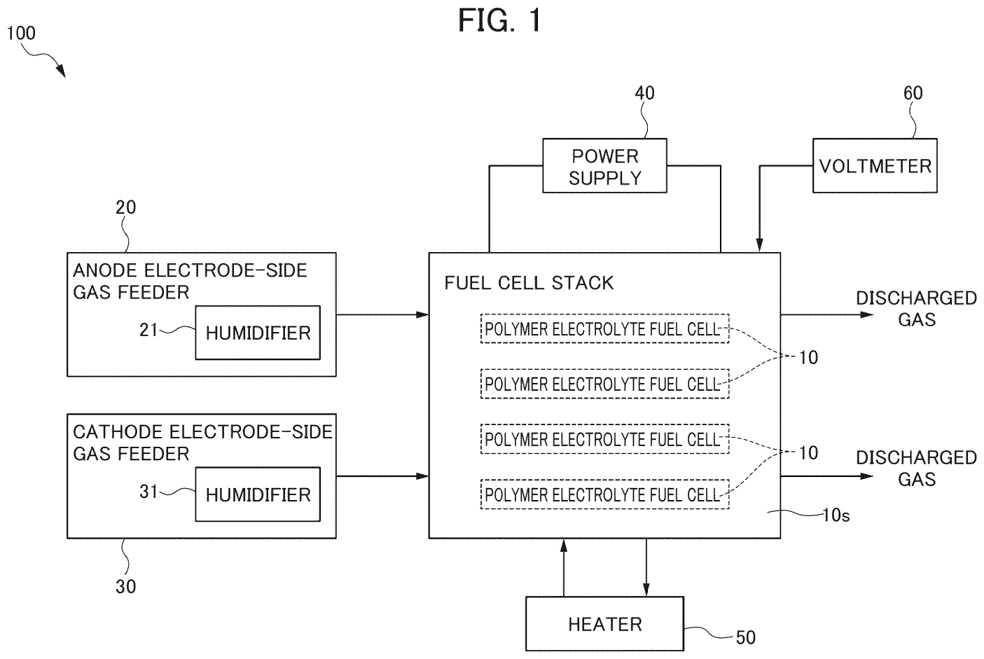

FIG. 1 is a block diagram illustrating an activation process apparatus that can be used in a method for activating a polymer electrolyte fuel cell according to an embodiment of the present invention.

The activation process apparatus 100 illustrated in FIG. 1 is adapted for activating a fuel cell stack 10s. The fuel cell stack 10s includes a plurality of polymer electrolyte fuel cells 10.

The activation process apparatus 100 includes an anode electrode-side gas feeder 20, a cathode electrode-side gas feeder 30, a power supply 40, a heater 50, and a voltmeter 60.

The anode electrode-side gas feeder 20 includes a humidifier 21. The anode electrode-side gas feeder 20 pressurizes and feeds a hydrogen-containing humidification gas, which has been humidified, to the anode electrodes of the polymer electrolyte fuel cells 10. The cathode electrode-side gas feeder 30 includes a humidifier 31. The cathode electrode-side gas feeder 30 pressurizes and feeds an oxygen-containing humidification gas, which has been humidified, or a nitrogen-containing humidification inert gas, which has been humidified, to the cathode electrodes of the polymer electrolyte fuel cells 10.

The power supply 40 is connected to the fuel cell stack 10s and applies a voltage between the cathode electrode and anode electrode of each polymer electrolyte fuel cell 10 during the activation process. The heater 50 heats the polymer electrolyte fuel cells 10 to a predetermined temperature. The voltmeter 60 measures an output voltage of the polymer electrolyte fuel cells 10. A state of the fuel cell stack 10s can be monitored based on the output voltage measured by the voltmeter 60.

Next, a method for activating a polymer electrolyte fuel cell according to an embodiment of the present invention, which uses the activation process apparatus 100 will be described.

### First Embodiment

A method for activating a polymer electrolyte fuel cell according to a first embodiment includes heating the fuel cell stack 10s at a set temperature using the heater 50. The set temperature is within the range preferably from 100° C. to 300° C., more preferably from 100° C. to 200° C., and still more preferably from 100° C. to 150° C. In the present embodiment, while the fuel cell stack 10s is heated, a hydrogen-containing humidification gas generated by the anode electrode-side gas feeder 20 is pressurized and fed to the anode electrodes of the polymer electrolyte fuel cells 10, and an oxygen-containing humidification gas or a nitrogen-containing humidification inert gas generated by the cathode electrode-side gas feeder 30 is pressurized and fed to the cathode electrodes of the polymer electrolyte fuel cells 10. As the hydrogen-containing gas, a hydrogen-containing gas or a hydrogen-nitrogen mixed gas can be used, for example. As the oxygen-containing gas, air, pure oxygen gas, or an oxygen-nitrogen mixed gas can be used, for example. As the nitrogen-containing humidification inert gas, an inert gas that contains nitrogen and is free of air and pure oxygen gas can be used.

When the humidification gases, i.e., the hydrogen-containing humidification gas and the oxygen-containing humidification gas or the nitrogen-containing humidification inert gas are fed to the polymer electrolyte fuel cells 10 in parallel with heating the fuel cell stack 10s, the relative humidity of each humidification gas decreases, thereby giving rise to a concern that activation of the anode electrodes and the cathode electrodes by water vapor may be retarded from progressing. For this reason, in the present embodiment, the humidification gases are pressurized to be fed to the polymer electrolyte fuel cells 10. Each humidification gas has a pressure within the range preferably from 0 kPaG to 8952 kPaG, more preferably from 0 kPaG to 1464 kPaG, and still more preferably from 0 kPaG to 375 kPaG. When fed to the polymer electrolyte fuel cells 10, the humidification gases may experience a temperature rise that can reduce the humidity of the gases. In order to suppress this reduction in humidity, the humidification gases may be heated to the temperature set for heating the fuel cell stack 10s so that the dew point of the humidification gases are adjusted to the set temperature.

The present embodiment may include applying a voltage fluctuating in a predetermined range between the cathode electrode and the anode electrode of each polymer electrolyte fuel cell 10 with the cathode electrode set to positive, while heating the fuel cell stack 10s. The condition for applying the voltage may be that potential scanning in the potential range from 0.01 V to 1.0 V is performed in a cycle within the range from 10 seconds to 60 seconds. Application of the voltage further facilitates the progress of the activation of the polymer electrolyte fuel cells 10. The voltage may be applied continuously or intermittently.

In the present embodiment, the hydrogen-containing humidification gas may be continuously or intermittently fed to the anode electrodes. The oxygen-containing humidification gas or the nitrogen-containing humidification inert gas may be continuously or intermittently fed to the cathode electrodes. Alternatively or additionally, the oxygen-containing humidification gas and the nitrogen-containing humidification inert gas may be intermittently fed to the cathode electrodes in a switching manner.

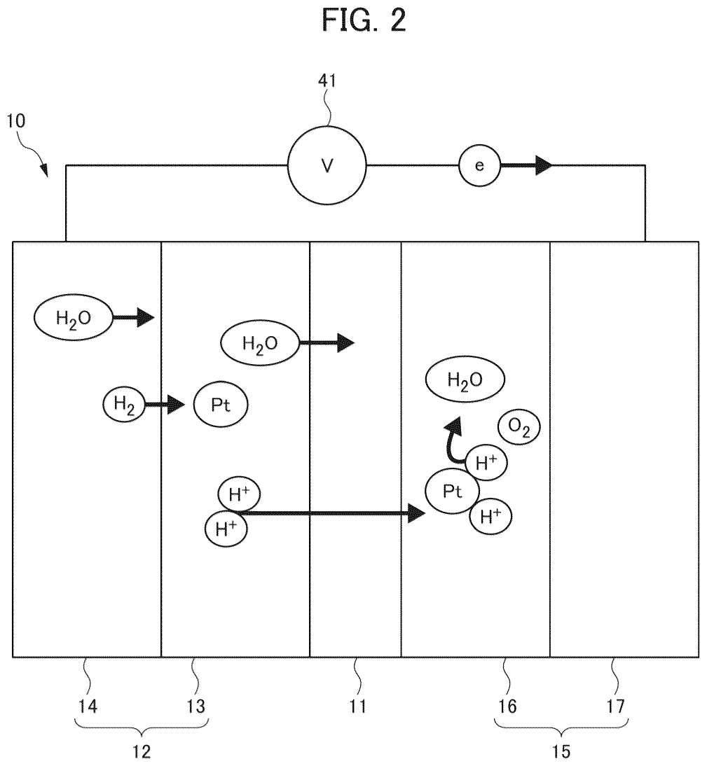

FIG. 2 is a schematic diagram illustrating an example of a state in which a polymer electrolyte fuel cell is being activated by a method for activating a polymer electrolyte fuel cell according to an embodiment of the present invention. In the example illustrated un FIG. 2, an oxygen-containing humidification gas is fed to the cathode electrode.

As illustrated in FIG. 2, the polymer electrolyte fuel cell 10 has a membrane electrode assembly in which an anode electrode 12 and a cathode electrode 15 are opposed to each other with a solid polymer membrane 11 interposed therebetween. The anode electrode 12 includes an anode-side catalyst layer 13 in contact with the solid polymer membrane 11, and an anode-side gas diffusion layer 14 disposed on a side of the anode-side catalyst layer 13 opposite to the solid polymer membrane 11. The cathode electrode 15 includes a cathode-side catalyst layer 16 in contact with the solid polymer membrane 11, and a cathode-side gas diffusion layer 17 disposed on a side of the cathode-side catalyst layer 16 opposite to the solid polymer membrane 11. A voltage regulator 41 regulates a voltage applied between the anode electrode 12 and the cathode electrode 15 during the activation process. The voltage regulator 41 is connected to the power supply 40.

The hydrogen-containing humidification gas fed to the anode electrode 12 passes through the anode-side gas diffusion layer 14 to reach the anode-side catalyst layer 13. In the anode-side catalyst layer 13, hydrogen (H2) in the hydrogen-containing humidification gas reduces deposits on the surface of the catalyst (Pt) and removes them to activate the catalyst, and thereby becomes protons (H⁺). Electrons generated at this time are transferred to the cathode side through an external circuit. The protons are transferred to the cathode-side catalyst layer 16 by a hydrogen pump. The protons transferred to the cathode-side catalyst layer 16 receive electrons and bond to oxygen, thereby generating water. The water vapor (H₂O) contained in the hydrogen-containing humidification gas moistens the anode-side catalyst layer 13. When the anode-side catalyst layer 13 is moistened, a proton path is formed in the anode-side catalyst layer 13, and protons are easily transferred to the solid polymer membrane 11. Furthermore, water (H₂O) contained in the hydrogen-containing humidification gas moves to the solid polymer membrane 11 to moisten the solid polymer membrane 11.

The oxygen-containing humidification gas fed to the cathode electrode 15 passes through the cathode-side gas diffusion layer 17 to reach the cathode-side catalyst layer 16. Water vapor (H₂O) contained in the oxygen-containing humidification gas activates the catalyst by removing deposits from the surface of the catalyst (Pt) and moistening the cathode-side catalyst layer 16. Oxygen (O₂) in the oxygen-containing humidification gas reacts with protons (H⁺) transferred from the anode on the catalyst, thereby generating water (H₂O). In a case where a nitrogen-containing humidification inert gas is fed to the cathode electrode 15, the nitrogen-containing humidification inert gas passes through the cathode-side gas diffusion layer 17 to reach the cathode-side catalyst layer 16. Water vapor (H₂O) contained in the nitrogen-containing humidification inert gas activates the catalyst by removing deposits from the surface of the catalyst (Pt) and moistening the catalyst layer.

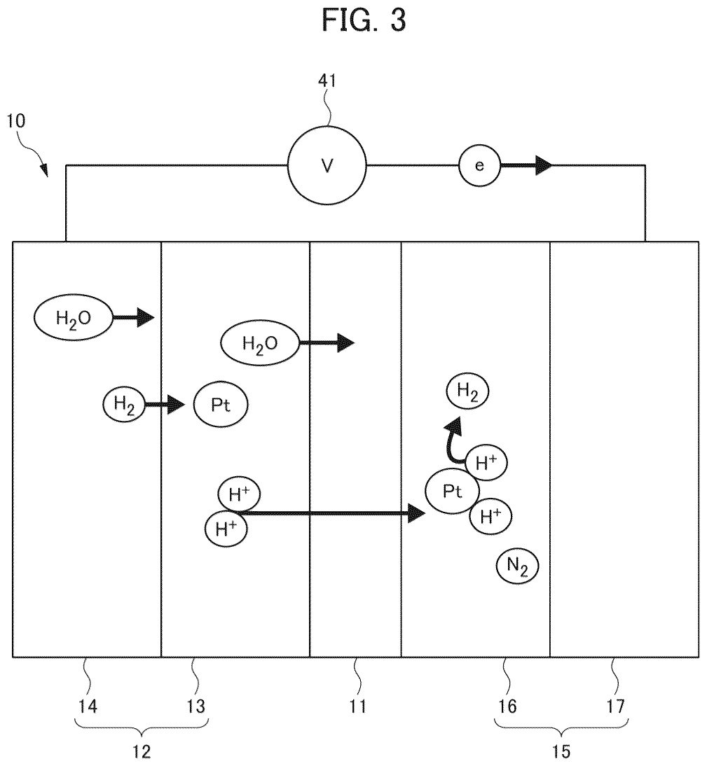

FIG. 3 is a schematic diagram illustrating another example of a state in which a polymer electrolyte fuel cell is being activated by a method for activating a polymer electrolyte fuel cell according to an embodiment of the present invention. Since the state in FIG. 3 is the same as the state in FIG. 2 except that the nitrogen-containing humidification inert gas is fed to the cathode electrode, the same components are denoted by the same reference numerals and description thereof is omitted.

Hydrogen (H₂) in a hydrogen-containing humidification gas fed to the anode electrode 12 becomes protons (H⁺) as in the case illustrated in FIG. 2, and are transferred to the cathode-side catalyst layer 16 by a hydrogen pump. The protons transferred to the cathode-side catalyst layer 16 receive electrons, thereby generating hydrogen (H₂). The nitrogen-containing humidification inert gas fed to the cathode electrode 15 passes through the cathode-side gas diffusion layer 17 to reach the cathode-side catalyst layer 16. Water vapor (H₂O) contained in the nitrogen-containing humidification inert gas activates the catalyst by removing deposits from the surface of the catalyst (Pt) and moistening the cathode-side catalyst layer 16.

In the above-described way, the polymer electrolyte fuel cells 10 are activated. The termination of the activation process can be determined with reference to an output voltage measured by the voltmeter 60.

According to the above-described method for activating a polymer electrolyte fuel cell of the present embodiment, the hydrogen-containing humidification gas is fed to the anode electrode 12, and the oxygen-containing humidification gas or the nitrogen-containing humidification inert gas is fed to the cathode electrode 15, while the fuel cell stack 10s is being heated at a high temperature of 100° C. or higher by the heater 50. This feature promotes desorption of impurities from the catalyst and moistening of the anode-side catalyst layer 13, the cathode-side catalyst layer 16, and the solid polymer membrane 11 by water vapor, whereby the activation of the catalyst easily progresses. Furthermore, since the hydrogen-containing humidification gas and the oxygen-containing humidification gas or the nitrogen-containing humidification inert gas are pressurized, water vapor can be efficiently supplied to the anode electrode 12 and the cathode electrode 15. As a result, the polymer electrolyte fuel cell 10 can be activated in a shorter time.

### Second Embodiment

A method for activating a polymer electrolyte fuel cell according to a second embodiment includes heating a fuel cell stack 10s at a set temperature by using a heater 50. The set temperature is within the range preferably from 100° C. to 300° C., more preferably from 100° C. to 200° C., and still more preferably 100° C. to 150° C. In the present embodiment, after the set temperature is reached, heating by the heater 50 is stopped. Humidification gases are fed to the anode electrode and the cathode electrode of the fuel cell stack 10s in a state in which the heating is stopped. Since the temperature of the fuel cell stack 10s drops due to the stop of the heating, even if the humidification gases are fed to the anode electrode and the cathode electrode at temperatures lower than those in the first embodiment, the water vapor can be efficiently supplied to each of the anode electrode and the cathode electrode. Therefore, in the present embodiment, the humidification gases fed to the anode electrode and the cathode electrode do not have to be pressurized. The humidification gas fed to the anode electrode and that fed to the cathode electrode are the same as those in the first embodiment. The humidification gases may be continuously or intermittently fed to the anode electrode and cathode electrode. Alternatively or additionally, the cathode electrode may be intermittently fed with the oxygen-containing humidification gas and the nitrogen-containing humidification inert gas in a switching manner. Alternatively or additionally, as in the first embodiment, a voltage fluctuating in a predetermined range may be applied between the cathode electrode and the anode electrode of each polymer electrolyte fuel cell 10 with the cathode electrode set to positive.

According to the method for activating a polymer electrolyte fuel cell of the present embodiment, the fuel cell stack 10s is heated until activation of the polymer electrolyte fuel cells 10 progresses, and following stop of the heating, the hydrogen-containing humidification gas is fed to the anode electrode and the oxygen-containing humidification gas or the nitrogen-containing humidification inert gas is fed to the cathode electrode. Due to this feature, water vapor can be efficiently supplied to the anode electrode and the cathode electrode without having to pressurize the hydrogen-containing humidification gas and the oxygen-containing humidification gas or the nitrogen-containing humidification inert gas. The gases may be fed to the anode electrode and the cathode electrode during the heating of the fuel cell stack 10s.

### EXAMPLES

### Example 1

An activation process was performed on a polymer electrolyte fuel cell under the following conditions until predetermined cell characteristics were obtained.
(i) Heating temperature: the polymer electrolyte fuel cell was heated at 120° C. (until the end of activation process)
(ii) Hydrogen-containing humidification gas: a hydrogen-nitrogen mixed gas was fed to the cathode electrode at a gas temperature of 120° C. (a dew point of 120° C.) and at a pressure of 98 kPaG.
(iii) Oxygen-containing humidification gas: an oxygen-nitrogen mixed gas was fed to the anode electrode at a gas temperature of 120° C. (a dew point of 120° C.) and at a gas pressure of 98 kPaG.
(iv) Voltage application condition: An operation was repeated in which a voltage was held at 0.03 V for 10 seconds, and thereafter, potential scanning from 0.03 V to 0.9 V was performed for 30 seconds.

### Example 2

An activation process was performed on a polymer electrolyte fuel cell under the same conditions as in Example 1 except that the heating was stopped upon the temperature of the polymer electrolyte fuel cell reaching 120° C., and the hydrogen-containing humidification gas and the oxygen-containing humidification gas were at normal pressure.

By performing the processes for activating the polymer electrolyte fuel cell of Example 1 and Example 2, the time until the polymer electrolyte fuel cell is activated becomes shorter as compared with the case where the hydrogen-containing humidification gas and the oxygen-containing humidification gas at atmospheric pressure are fed while the polymer electrolyte fuel cell is heated at 120° C.

### EXPLANATION OF REFERENCE NUMERALS

10: Polymer electrolyte fuel cell
10s: Fuel cell stack
11: Solid polymer membrane
12: Anode electrode
13: Anode-side catalyst layer
14: Anode-side gas diffusion layer
15: Cathode electrode
16: Cathode-side catalyst layer
17: Cathode-side gas diffusion layer
20: Anode electrode-side gas feeder
21: Humidifier
30: Cathode electrode-side gas feeder
31: Humidifier
40: Power supply
41: Voltage regulator
50: Heater
60: voltmeter
100: Activation process apparatus

What is claimed is:

1. A method for activating a polymer electrolyte fuel cell having a membrane electrode assembly in which an anode electrode and a cathode electrode are opposed to each other with a solid polymer membrane interposed therebetween, the method comprising:
pressurizing and feeding a hydrogen-containing humidification gas, which has been humidified, to the anode electrode and pressurizing and feeding an oxygen-containing humidification gas, which has been humidified, or a nitrogen-containing humidification inert gas, which has been humidified, to the cathode electrode, while heating the polymer electrolyte fuel cell at a set temperature in a predetermined range.

2. The method according to claim 1, wherein
the hydrogen-containing humidification gas and the oxygen-containing humidification gas are heated to the set temperature.

3. The method according to claim 1, further comprising:
applying a voltage fluctuating in a predetermined range between the cathode electrode and the anode electrode with the cathode electrode set to positive, while heating the polymer electrolyte fuel cell.

4. A method for activating a polymer electrolyte fuel cell having a membrane electrode assembly in which an anode electrode and a cathode electrode are opposed to each other with a solid polymer membrane interposed therebetween, the method comprising:
heating the polymer electrolyte fuel cell at a set temperature in a predetermined range; and thereafter, feeding a hydrogen-containing humidification gas, which has been humidified, to the anode electrode and feeding an oxygen-containing humidification gas, which has been humidified, or a nitrogen-containing humidification inert gas, which has been humidified, to the cathode electrode in a state in which the heating is stopped.
